(19) United States
(12) Patent Application Publication
(10) Pub. No.: US 2007/0011713 A1
(43) Pub. Date: Jan. 11, 2007

(54) System and method of integrating video content with interactive elements

(76) Inventors: Nathan S. Abramson, Cambridge, MA (US); William Wittenberg, Lexington, MA (US)

Correspondence Address: CHOATE, HALL & STEWART LLP, TWO INTERNATIONAL PLACE, BOSTON, MA, 02110, US

(21) Appl. No.: 11/350,392

(22) Filed: Feb. 8, 2006

Related U.S. Application Data
(63) Continuation of application No. PCT/US04/25803, filed on Aug. 9, 2004.
(63) Continuation of application No. 10/637,924, filed on Aug. 8, 2003.
(63) Continuation of application No. 10/708,260, filed on Feb. 20, 2004.
(63) Continuation of application No. 10/708,267, filed on Feb. 20, 2004.
(63) Continuation of application No. 10/637,924, filed on Aug. 8, 2003.
Application No. 10/708,260 is a continuation of application No. 10/637,924, filed on Aug. 8, 2003.
(60) Provisional application No. 60/493,965, filed on Aug. 8, 2003.
(60) Provisional application No. 60/533,713, filed on Dec. 30, 2003.
(60) Provisional application No. 60/493,965, filed on Aug. 8, 2003.
(60) Provisional application No. 60/493,965, filed on Aug. 8, 2003.
(60) Provisional application No. 60/533,713, filed on Dec. 30, 2003.

(51) Int. Cl. H04N 7/173; G06F 15/00; G06F 17/00

(52) U.S. Cl. 725/113; 725/112; 715/501.1; 715/500.1; 725/109

(57) ABSTRACT

A client system for integrating interactivity with video including a first window, a second window and an application program. The first window displays video content and the second window displays interactive elements. The application program manages the first and second window to display the interactive elements semi-transparently superimposed over the video content. Related methods and articles of manufacture are also disclosed.

### RELATED APPLICATIONS

This application claims the benefit of PCT Patent Application. No. PCT/US2004/025803, which claims the benefit of U.S. Provisional Patent Application Ser. No. 60/493,965 filed Aug. 8, 2003, U.S. patent application Ser. No. 10/637,924 filed Aug. 8, 2003, U.S. Provisional patent application Ser. No. 10 60/533,713 filed Dec. 30, 2003, U.S. patent application Ser. No. 10/708,260 filed Feb. 20, 2004 and U.S. patent application Ser. No. 10/708,267 filed Feb. 20, 2004, all of which are incorporated herein by this reference.

### FIELD OF THE INVENTION

The present invention relates to interactive video applications and, more particularly, to systems and methods for integrating video content with interactive elements.

### BACKGROUND OF THE INVENTION

The worldwide network of computers commonly known as the “Internet” has two compelling advantages over traditional media as a selling tool. Those advantages are the immediacy of the media and the interactivity of the media. A website is able to present to a potential customer photos, audio clips, and streaming video that exhibit products and services to a potential customer. In addition, a website may receive input from the user to see other aspects of a proposed product or service or to place an order.

To date, however, integration of interactivity and visual immediacy has been limited. In particular, it would be desirable to have video integrated with interactive elements that are related to the subject matter of the video displayed to a potential customer. Such a system would benefit from the visual immediacy of video while using interactive elements to cross out other products and services related to the video. The present invention addresses this need.

### BRIEF SUMMARY OF THE INVENTION

The present invention provides a system and associated methods for displaying video content to a user and integrating with the video content one or more interactive elements that are displayed semi-transparently over the video. These interactive elements may be used to offer products and services to the viewer of the video. The products and services may be related to the subject matter of the video that is being displayed.

In one aspect, the present invention is related to a system for displaying media output integrated with display elements. The system includes a first window having a media player, and a second window having at least one of a plurality of display elements. The system also includes an application program configured to display output of the media player of the first window in a portion of the second window, and to superimpose, in the portion of the second window, the display of the least one of the plurality of display elements and the display of the output of the media player.

In one embodiment of the system of the present invention, the media player comprises a Windows Media Player application. In another embodiment, the output of the media player comprises video. In some embodiments, the application program is further configured to semi-transparently superimpose the display of the least one of the plurality of display elements and the display of the output of the media player. In other embodiments, the application program is further configured to display the least one of the plurality of display elements floating over the portion of the second window.

In another embodiment of the present invention, a size and location of the second window and a size and location of the first window are synchronized to obscure the view of the first window by the second window. In one embodiment, the second window comprises a clipping region configured to show the display of the output of the media player from the first window in the portion of the second window. In another embodiment, the second window comprises a clipping region configured to show in the portion of the second window the display of the least one of the plurality of display elements from the second window and the display of the output of the media player from the first window. In some embodiments, the position of the media player in the first window is synchronized with the position of the portion of the second window.

In yet another embodiment of the system of the present invention, the application program comprises a thread process. The application program may also include an ActiveX control or a JAVA applet. In one embodiment, the application program comprises an application programming interface to control the displaying of the output of the media player. In some embodiments, the application program provides an application programming interface to control the displaying of the least one of the plurality of display elements. In other embodiments, the application program provides an application programming interface to control the size and location of one of the first window and the second window.

In some embodiments of system of the present invention, the at least one of the plurality of display elements includes an interactive display element. In other embodiments, the at least one of the plurality of display elements includes text. In another embodiment, the at least one of the plurality of display elements includes graphics.

In another aspect, the present invention is related to method for integrating displaying of display elements with displaying of media output. The method includes(a) displaying the output of a media player in a first window, and displaying at least one of a plurality of display elements in a second window. The method also includes superimposing, in a portion of the second window, the displaying of the least one of the plurality of display elements and the displaying of the output of the media player.

In one embodiment of the method of the present invention, the media player includes a Windows Media Player application. In some embodiments, the method includes displaying video output of a media player in a first window. In other embodiments, the method includes semi-transparently superimposing, in the portion of the second window, the displaying of the least one of the plurality of display elements and the displaying of the output of the media player. The method may also include displaying the least one of the plurality of display elements floating over the portion of second window. In yet another embodiment, the method may include synchronizing a size and location of the second window with a size and location of the first window to obscure the view of the first window by the second window.

In other embodiments of the present invention, the method may configure a clipping region to show the display of the output of the media player from the first window in the portion of the second window. In some embodiments, the method may also include configuring a clipping region to show in the portion of the second window the display of the least one of the plurality of display elements from the second window and the display of the output of the media player from the first window. In one embodiment, the method also includes synchronizing the position of the media player in the first window with the position of the portion of the second window.

In some embodiments, the method includes providing an application programming interface to control the displaying of the output of the media player. In another embodiment, the method provides an application programming interface to control the displaying of the least one of the plurality of display elements. The method of the present invention may also provide an application programming interface to control the size and location of one of the first window and the second window.

In some embodiments of method of the present invention, the at least one of the plurality of display elements includes an interactive display element. In other embodiments, the at least one of the plurality of display elements includes text. In another embodiment, the at least one of the plurality of display elements includes graphics.

The details of various embodiments of the invention are set forth in the accompanying drawings and the description below.

### BRIEF DESCRIPTION OF THE DRAWINGS

The invention is pointed out with particularity in the appended claims. The advantages of the inventions described above, together with further advantages of the invention, may be better understood by referring to the following description in conjunction with the accompanying drawings, in which:

FIG. 1 is a block diagram of one embodiment of a client-server system in which the present invention can be used;

FIGS. 2A and 2B are block diagrams of embodiments of computers useful as a client node;

FIG. 3 depicts a block diagram of an embodiment of a client node useful in the present invention;

FIG. 4 is a flowchart depicting one embodiment of the steps taken to download a channel of content;

FIG. 5 is a flowchart depicting one embodiment of the steps taken to display an interactive element semi-transparently over video;

FIG. 6 is a schematic diagram depicting clipping behavior exhibited by some operating systems.

FIG. 7A is a schematic diagram depicting an embodiment of using clipping regions to display video content;

FIG. 7B is a schematic diagram depicting a clipping region for the embodiment shown in FIG. 7A;

FIG. 8A is a schematic diagram depicting an embodiments of using clipping regions to display an interactive display element over video content; and

FIG. 8B is a schematic diagram depicting a clipping region for the embodiment shown in FIG. 8A;

### DETAILED DESCRIPTION OF THE INVENTION

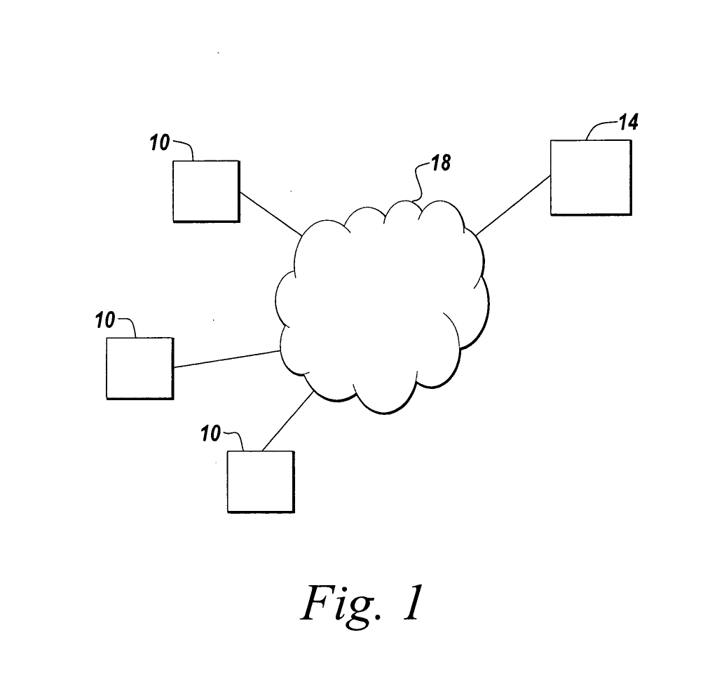

Referring now to FIG. 1, in brief overview, one embodiment of a client-server system in which the present invention may be used is depicted. A first computing system (client node) 10 communicates with a second computing system (server node) 14 over a communications network 18. In some embodiments the second computing system is also a client node 10. The topology of the network 18 over which the client nodes 10 communicate with the server nodes 14 may be a bus, star, or ring topology. The network 18 can be a local area network (LAN), a metropolitan area network (MAN), or a wide area network (WAN) such as the Internet.

The client and server nodes 10, 14 can connect to the network 18 through a variety of connections including standard telephone lines, LAN or WAN links (e.g., T1, T3, 56 kb, X.25, SNA, DECNET), broadband connections (ISDN, Frame Relay, ATM, Gigabit Ethernet, Ethernet-over-SONET), and wireless connections. Connections can be established using a variety of communication protocols (e.g.,.TCP/IP, IPX, SPX, NetBIOS, Ethernet, ARCNET, Fiber Distributed Data Interface (FDDI), RS232, IEEE 802.11, IEEE 802.11a, IEEE 802.11b, IEEE 802.11g, and direct asynchronous connections). Other client nodes and server nodes (not shown) may also be connected to the network 18.

The client nodes 10 and server nodes 14 may be provided as any device capable of displaying video and otherwise capable of operating in accordance with the protocols disclosed herein, such as personal computers, windows-based terminals, network computers, information appliances, X-devices, workstations, mini computers, personal digital assistants or cell phones. Similarly, the server node 14 can be any computing device that stores files representing video and interactive elements and is capable of interacting using the protocol disclosed herein. Further, server nodes 14 may be provided as a group of server systems logically acting as a single server system, referred to herein as a server farm. In one embodiment, the server node 14 is a multi-user server system supporting multiple concurrently active client connections.

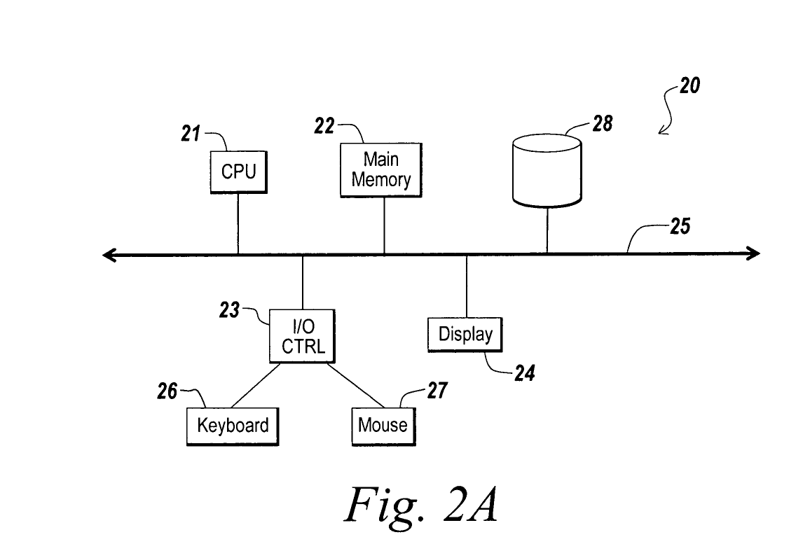

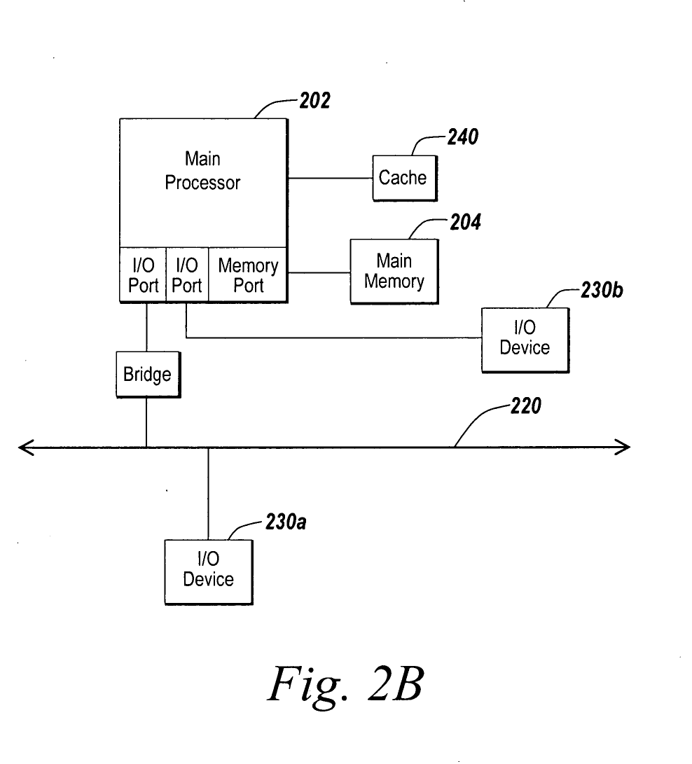

FIGS. 2A and 2B depict block diagrams of a typical computer 200 useful in the present invention. As shown in FIGS. 2A and 2B, each computer 200 includes a central processing unit 202, and a main memory unit 204. Each computer 200 may also include other optional elements, such as one or more input/output devices 230a-230b (generally referred to using reference numeral 230), and a cache memory 240 in communication with the central processing unit 202.

The central processing unit 202 is any logic circuitry that responds to and processes instructions fetched from the main memory unit 204. In many embodiments, the central processing unit is provided by a microprocessor unit, such as: the 8088, the 80286, the 80386, the 80486, the Pentium, Pentium Pro, the Pentium II, the Celeron, or the Xeon processor, all of which are manufactured by Intel Corporation of Mountain View, Calif.; the 68000, the 68010, the 68020, the 68030, the 68040, the PowerPC 601, the PowerPC604, the PowerPC604e, the MPC603e, the MPC603ei, the MPC603ev, the MPC603r, the MPC603p, the MPC740, the MPC745, the MPC750, the MPC755, the MPC7400, the MPC7410, the MPC7441, the MPC7445, the MPC7447, the MPC7450, the MPC7451, the MPC7455, the MPC7457 processor, all of which are manufactured by Motorola Corporation of Schaumburg, Ill.; the Crusoe TM5800, the Crusoe TM5600, the Crusoe TM5500, the Crusoe TM5400, the Efficeon TM8600, the Efficeon TM8300, or the Efficeon TM8620 processor, manufactured by Transmeta Corporation of Santa Clara, Calif.; the RS/6000 processor, the RS64, the RS 64 II, the P2SC, the POWER3, the RS64 III, the POWER3-II, the RS 64 IV, the POWER4, the POWER4+, the POWER5, or the POWER6 processor, all of which are manufactured by International Business Machines of White Plains, N.Y.; or the AMD Opteron, the AMD Athalon 64 FX, the AMD Athalon, or the AMD Duron processor, manufactured by Advanced Micro Devices of Sunnyvale, Calif. The client nodes 10 and server nodes 14 may be computers based on any of the above described processors, or other available processors capable of operating as described herein.

Main memory unit 204 may be one or more memory chips capable of storing data and allowing any storage location to be directly accessed by the microprocessor 202, such as Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC100 SDRAM, Double Data Rate SDRAM (DDR SDRAM), Enhanced SDRAM (ESDRAM), SyncLink DRAM (SLDRAM), Direct Rambus DRAM (DRDRAM), or Ferroelectric RAM (FRAM). In the embodiment shown in FIG. 2A, the processor 202 communicates with main memory 204 via a system bus 220 (described in more detail below). FIG. 2B depicts an embodiment of a computer system 200 in which the processor communicates directly with main memory 204 via a memory port. For example, in FIG. 2B the main memory 204 may be DRDRAM.

FIGS. 2A and 2B depict embodiments in which the main processor 202 communicates directly with cache memory 240 via a secondary bus, sometimes referred to as a “backside” bus. In other embodiments, the main processor 202 communicates with cache memory 240 using the system bus 220. Cache memory 240 typically has a faster response time than main memory 204 and is typically provided by SRAM, BSRAM, or EDRAM.

In the embodiment shown in FIG. 2A, the processor 202 communicates with various I/O devices 230 via a local system bus 220. Various busses may be used to connect the central processing unit 202 to the I/O devices 230, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is an video display, the processor 202 may use an Advanced Graphics Port (AGP) to communicate with the display. FIG. 2B depicts an embodiment of a computer system 200 in which the main processor 202 communicates directly with I/O device 230b via HyperTransport, Rapid I/O, or InfiniBand. FIG. 2B also depicts an embodiment in which local busses and direct communication are mixed: the processor 202 communicates with I/O device 230a using a local interconnect bus while communicating with I/O device 230b directly.

A wide variety of I/O devices 230 may be present in the computer system 200. Input devices include keyboards, mice, trackpads, trackballs, microphones, and drawing tablets. Output devices include video displays, speakers, inkjet printers, laser printers, and dye-sublimation printers. An I/O device may also provide mass storage 28 for the computer system 200 such as one or more hard disk drives, redundant arrays of independent disks, a floppy disk drive for receiving floppy disks such as 3.5-inch, 5.25-inch disks or ZIP disks, a CD-ROM drive, a CD-R/RW drive, a DVD-ROM drive, tape drives of various formats. In still other embodiments, the computer 20 may provide USB connections to receive handheld USB storage devices such as the USB Flash Drive line of devices manufactured by Twintech Industry, Inc. of Los Alamitos, Calif.

In further embodiments, an I/O device 230 may be a bridge between the system bus 220 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

General-purpose desktop computers of the sort depicted in FIGS. 2A and 2B typically operate under the control of operating systems, which control scheduling of tasks and access to system resources. The client node 10 and the server node 14 may operate under the control of a variety of operating systems. Typical operating systems include: WINDOWS 3.x, WINDOWS 95, WINDOWS 98, WINDOWS 2000, WINDOWS NT 3.51, WINDOWS NT 4.0, WINDOWS CE, and WINDOWS XP, all of which are manufactured by Microsoft Corporation of Redmond, Wash.; MacOS, manufactured by Apple Computer of Cupertino, Calif.; OS/2, manufactured by International Business Machines of Armonk, N.Y.; and Linux, a freely-available operating system distributed by Caldera Corp. of Salt Lake City, Utah, Java or Unix, among others.

In other embodiments, the client node 10 may have different processors, operating systems, and input devices consistent with the device. For example, in one embodiment the client node is a Zire 71 personal digital assistant manufactured by Palm, Inc. In this embodiment, the Zire 71 operated under the control of the PalmOS operating system and includes a stylus input device as well as a five-way navigator device.

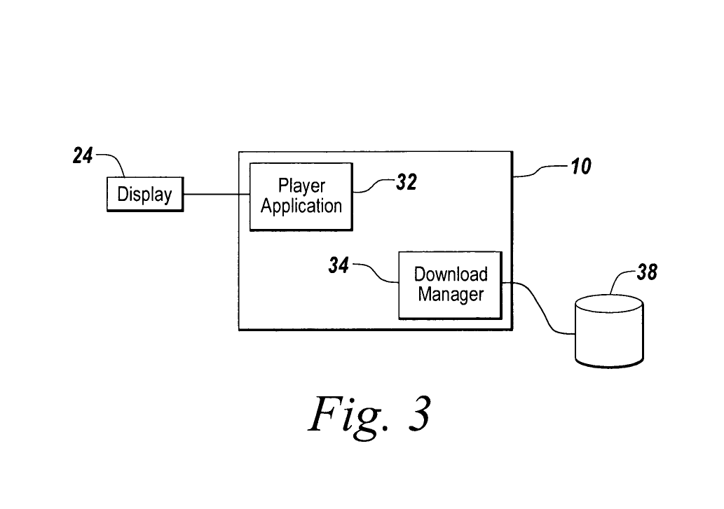

As shown in FIG. 3, a client node 10 useful in connection with the present invention includes a player application 32 and a download manager 34. The player application 32 and the download manager 34 may be provided as software applications permanently stored on a hard disk drive 28 and moved to main memory 22 for execution by the central processor 21 In these embodiments, the player application 32 and the download manager may be written in any one of a number of suitable programming languages, such a PASCAL, C, C+, C++, C#, or JAVA and may be provided to the user on articles of manufacture such as floppy disks, CD-ROMS, or DVD-ROMs. Alternatively, the player application 32 and the download manager 34 may be downloaded from a server node 14 by the user.

In other embodiments, the player application 32 and the download manager 34 may be provided as special-purpose hardware units dedicated to their respective functions. In these embodiments, the player application 32 and the download manager 34 may be provided as application-specific integrated circuits (ASICs), field-programmable gate arrays (FPGAs), programmable-logic devices (PLDs), programmable array logics (PALs), programmable read-only memories (PROMs), or electrically-erasable programmable read-only memory (EEPROMs).

The download manager 34 downloads and stores locally content to be displayed by the player application 32. Although downloaded data may be stored in any form of persistent storage such as tape media, compact disc media, or floppy disk media, it is preferred that the download manager store downloaded data on a hard drive associated with the client node 10.

Before beginning a detailed discussion of the process used by the download manager 34 for downloading content, a brief introduction of the terms used in this document to identify various forms of content will be helpful. The terms introduced here are: channel; program; shelf; bundle; and content file.

A “channel” refers to an HTML application, e.g. a downloadable “mini web site,” that acts as the “player” for its programs. Channels may be thought of as “mini applications” or “custom players” for “programs,” which are described below. Both channels and programs are represented as directory structures containing content files, similar to the way a web site is structured as a hierarchy of directories and files. When the download manager 34 downloads a channel or program, it downloads a complete directory structure of files. A channel is also the object that owns programs, so if a channel is removed, its corresponding programs are also removed. Every channel is identified by a unique identifier referred to herein as an entityURI. The download manager 34 is made aware of channels when the channel's entityURI is passed through an API call made by an ActiveX object, which can be invoked by JavaScript in a web page. A channel also has an associated object that represents the contents of a version of the channel. During the download of an update to the channel, a new channel version object is created to represent the version of the channel being downloaded. When the new version is completely downloaded, the current channel version object is deleted and the new channel version object becomes the current channel version object. The channel version object includes a version number that is assigned by the source of the channel and is returned in response to a request for information about the channel made by the download manager 34. When the channel source returns a channel version object having a higher version number than the one currently stored by the download manager 34, it indicates to the download manager 34 that a new version of the channel is available for download. The download manager 34 creates a new channel version object and begins to download the new version of the channel.

A “program” is similar in structure to a channel. Like a channel, a program has a version number maintained by its source and the download manager 34 can begin downloading a new version of the program if it detects that the program's version number has increased. Like channels, programs are identified for download through ActiveX API calls. However, these API calls are usually made by the channel itself. A program is associated with a single channel. If the associated channel is removed from the client node 10, the program is removed as well.

As used herein, a “shelf” refers to subdivisions of the programs associated with a channel. When a program is downloaded, the download manager 34 may add the program to a specific shelf of a channel. Shelves represent a level of indirection between channels and programs, i.e., a channel doesn't own programs, instead a channel owns shelves, and the shelves own programs. Shelves are created and removed using ActiveX API's. Every channel has a “default shelf” which is created when the channel is added. In some embodiments, shelves are used to implement different rules for saving programs. For example, programs associated with one shelf may be deleted after one day, while programs associated with another shelf may be saved until the user explicitly deletes them.

As used in this document a “bundle” refers to a virtual directory structure that maps directory names, e.g., “images/logo.gif,” to content files. The mapping is stored as XML in a content file. The content file storing the mapping is referred to as the bundle's descriptor. A bundle can be used in one of four ways: (1) as a synopsis bundle of a program; (2) as a content bundle of a program; (3) as the synopsis bundle of a channel; (4) or as the content bundle of a channel. In every case, a bundle is associated with either a program or a channel and may be stored in a respective program version object or channel version object.

As used in this document, a “content bundle” refers to a set of content files grouped into a virtual directory structure. A content bundle identifies the bulk of the channel or program content, and may be thought of as “the channel” or “the program.” The content bundle identifies each content file identified by the channel and indicates where that file is located in the virtual directory structure. One embodiment of a content bundle is shown below:

index.html→http://www.content.com/contentAuthority#7291332

images/logo.gif→http://www.content.com/contentAuthority#15930531

images/spacer.gif→http://www.content.com/contentAuthority#9399203

The left hand side of each mapping is the name of the file within the content bundle's virtual directory structure. The right hand side of each mapping is the entityURI of a corresponding content file representing a single version of any particular item of content, e.g., an HTML file, an image, a video, etc. If a content file is changed, it is represented as a new content file with a new globally-unique entityURI. Thus, if a content file contained in a channel changes, a completely new content file is reissued and the appropriate content bundle is modified to “point” to the new content file.

As used herein, a content file represents one of the content file entities described above. It keeps track of the URL for getting an actual file, where the file is on the local disk, and how much of the file has been downloaded. Content files are referenced by bundles. Because content files can be shared between channels and programs, a content file might be referenced by more than one bundle. Alternatively, a content file might not be referenced by bundles. For example, in some embodiments when a program is deleted, its content files are not deleted at the same time. This is advantageous in embodiments in which other programs include the same content file. Content files include traditional forms of content, such as video and audio, as well as interactive elements to be displayed to the user. For example, a content file may store an interactive element that offers for sale products or services related to other content in the channel. A specific example of this is video from a magazine source, such as National Geographic or Time Magazine, having an interactive element soliciting magazine subscriptions displayed semi-transparently over the running video.

The three basic elements of the content distribution system: channels; programs; and content files, are referred to herein as entities. Each entity has a globally-unique entityURI, which both uniquely identifies the entity and contains enough information to locate the entity. In one embodiment, an entityURI has the following format:
http://www.mycompany.com/contentAuthority#33958193020193

In this embodiment, the entityURI includes a content source Uniform Resource Locator address (URL), i.e., http://www.mycompany.com/contentAuthority, and an identification code identifying the file, i.e., #33958193020193. In some embodiments, the entityURI is not human-readable. In some embodiments, the entityURI is a URL, i.e., it does not include the “#” symbol separating the identification code from the remainder of the entityURI. In these embodiments, the entityURI may be represented in the following manner: http://www.mycompany.coin/contentAuthority/3395893020193. Still further embodiments may include a mixture of both forms of entityURIs.

Although there are several utilities that can represent a directory of files in a single file making it easy to transport an entire directory of files—.ZIP files are widely used in personal computers running a WINDOWS-based operating system and .TAR files are often used on computers running a UNIX-based operating system—this approach is not used in the present invention for two reasons. First, it is possible that several channels or programs will share the same files, for example, multiple programs might all include the same advertisement. Downloading this content multiple times would consume additional time and bandwidth. The second reason for avoiding this approach is that channels and programs may be updated often, sometimes with minor changes. In these cases, the download cost can be minimized by only transporting those files that have changed, without having to transport an entire .ZIP or .TAR file.

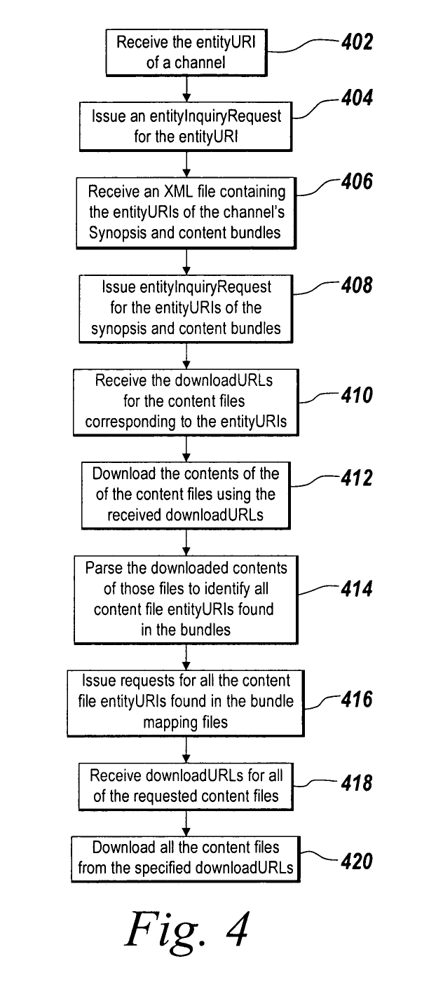

FIG. 4 depicts the steps taken by the download manager 34 to download a channel of content. In brief overview, the process for downloading a channel includes the steps of: receiving the entityURI of a channel (step 402); issuing a request for information about the entityURI (step 404); receiving an XML file containing the entityURIs of the channel's synopsis and content bundles (step 406); issuing requests for information about the entityURIs of the synopsis and content bundles; (step 408); receiving an XML file containing the entityURLs for the synopsis and content bundles (step 410); downloading the contents of the files identified by the received entityURLs for the synopsis and content bundles (step 412); parsing the downloaded contents of those files to identify all content file entityURLs found in the bundles (step 414); issuing requests for all the content file entityURLs found in the bundle mapping files (step 416); receiving downloadURLs for all of the requested content files (step 418); and downloading all the content files from the specified downloadURLs (step 420).

Still referring to FIG. 4, and in more detail, the process for downloading a channel begins by receiving the entityURI of a channel (step 402). An exemplary channel entityURI is reproduced below:

http://theartist.tld.net/contentAuthority/channels/TheArtistJukebox

In some embodiments, the entityURI is “pushed” to the download manager 34 by a server node 14. For example, a user of a client node 10 may access a web site that makes a JavaScript call to a function exposed by the download manager 34. That function call passes the entityURI of the channel to be downloaded. In other embodiments, the entityURI may be “pulled” by the client node 10 by, for example, clicking on a hyperlink that delivers to the download manager 34 the entityURI. In still other embodiments the download manager 34 may retrieve entityURLs from an article of manufacture, such as a CD-ROM or DVD-ROM, having the entityURLs embodied thereon.

Once the download manager 34 has the entityURI of a channel, it issues a request for more information about the entityURI of the channel (step 404). Using the exemplary channel entityURI reproduced above, the download manager would issue an HTTP GET request to http://theartist.tld.net/contentAuthority/channels/TheArtistJukebox. In some embodiments, this request is made via an HTTP POST request to the content source identified in the entityURI, i.e., http://www.mycompany.com/contentAuthority. In some of these embodiments, the HTTP POST request includes an XML document including additional information about the request.

Upon receipt of the request, the download manager 34 receives information about the channel transmitted by the content source (step 406). In some embodiments, the content source transmits an XML file to the download manager 34. An exemplary XML received by the download manager in these embodiments is:

```
<contentAuthorityResponse
xmlns=“http://www.tld.net/xml/ns/ContentAuthorityResponse”>
  <channelInfo
entityURI=“http://theartist.tld.net/contentAuthority/channels/
TheArtistJukebox/channelEntity.xml”
synopsisBundleURI=“http://theartist.tld.net/contentAuthority/
Ba53de4cf68c7cd995cD7c9910d1d1d45.xml”
contentBundleURI=“http://theartist.tld.net/contentAuthority/
Ba53de4cf68c7cd995cD7c9810d1d1d45.xml”
    version=“1058919065331”
    />
</contentAuthorityResponse>
```

The first field identifies the file as a response to the HTTP GET request issued by the download manager 34. In the example above, the information transmitted to the download manager 34 includes an identification of the entityURI, a “synopsis” of the channel (the synopsisBundleURI) and a content bundle (the contentBundleURI). The example reproduced above includes an identification of the current version of the channel, i.e. version=1058919065331. In some embodiments, the synopsis includes a very small amount of information, such as metadata describing the channel or, in some embodiments, a “teaser” image. Because the synopsis is small, a download manager 34 is able to load this information very quickly. This allows a client node to display information about a channel immediately without waiting to download the content for a channel, which is usually much larger than the synopsis and, therefore, takes longer to download.

The download manager 34 requests more information about the entityURI of the content bundle and the entityURI of the synopsis bundle (step 408). In some embodiments the client node issues these requests as HTTP POST requests. For example, to retrieve information relating to the synopsis bundle, the download manager 34 may issue an HTTP GET request to http://theartist.tld.net/contentAuthority/Ba53de4cf68c7cd995cD7c9910dldld45.xml. A similar process is followed for the content bundle. The download manager 34 may issue the requests serially, or it may issue several requests for information in a single HTTP POST request. For embodiments in which the entityURI is a URL (such as in the example above), the download manager 34 issues an HTTP GET request instead of an HTTP POST request. In these embodiments, only a single request is issued at a time. The XML files for the synopsis and the content bundle do not need to be stored on the same server node 14. Thus, in some embodiments, a “synopsis server” and a “content server” may be used to implement the present invention.

In response to the requests, the client node 10 receives information about the synopsis and content files of a particular channel (step 410). An example of the response transmitted to the client node 10 in response to a request for information relating to the content bundle is reproduced below:

```
<contentAuthorityResponse
xmlns=“http://www.tld.net/xml/ns/ContentAuthorityResponse”>
  <contentFileInfo
entityURI=“http://theartist.tld.net/contentAuthority/
Ba53de4cf68c7cd995cD7c9810d1d1d45.xml”
downloadURL=“http://theartist.tld.net/content/channel/
Ba53de4cf68c7cd995cD7c9810d1d1d45.xml.bnd.xml”
    />
</contentAuthorityResponse>
```

The downloadURL, i.e., http://theartist.tld.net/content/channel/Ba53de4cf68c7cd995cD7c9810dldld45.xml.bnd. xml, indicates from where the client node 10 can download the bundle's descriptor. In some embodiments, the content source may choose downloadURLs based on load, physical location, network traffic, affiliations with download sources, etc. In some embodiments, the server node 14 responds with URL addresses identifying files for the download manager 34 to download. In some embodiments, the server node 14 uses a “prefetch” algorithm to transmit to the download manager 34 information about related entityURLs about which the server node 14 predicts the download manager 34 will request information in the future.

The download manager 34 then downloads the bundle descriptor (step 412). In the example being followed, the download manager receives:

```
<bundle xmlns=“http://www.tld.net/xml/ns/Bundle”>
  <contentFile
entityURI=“http://theartist.tld.net/contentAuthority//
La53de4cf68c7cd995cD7cb710d1d1d45.xml” name=“images/
wave.jpg” />
  <contentFile
entityURI=“http://theartist.tld.net/contentAuthority/
La53de4cf68c7cd995cD7cb810d1d1d45.xml” name=“logos/
labelLogo.gif” />
  <contentFile
entityURI=“http://theartist.tld.net/contentAuthority/
La53de4cf68c7cd995cD7cb910d1d1d45.xml” name=“images/
top.gif” />
  <contentFile
entityURI=“http://theartist.tld.net/contentAuthority/
La53de4cf68c7cd995cD7cba10d1d1d45.xml” name=“register.js” />
  <contentFile
entityURI=“http://theartist.tld.net/contentAuthority/
La53de4cf68c7cd995cD7cbb10d1d1d45.xml” name=“register.
html” />
  <contentFile
entityURI=“http://theartist.tld.net/contentAuthority/
La53de4cf68c7cd995cD7cbc10d1d1d45.xml” name=“playMenu.
xsl”/>
  ...
</bundle>
```

As described above, and as shown in the example above, a bundle file is an XML file mapping files in a virtual file structure to physical addresses at which the file can be located. The download manager 34 parses the received files to identify all content files required for a channel (step 414). The download manager 34 determines if it has already downloaded any of the identified files. In some embodiments it does this by comparing the entityURI of each identified file with the entityURI of each file the download manager 34 has already downloaded and stored locally.

For each file identified in the bundle that the download manager 34 has not already retrieved, the download manager 34 issues requests more information about each of the files identified (step 416). In some embodiments, these requests are HTTP POST requests. For example, in the example above, the download manager 34 issues an HTTP GET request to http://theartist.tld.net/contentAuthority/La53de4cf68c7cd995cD7cb710dldld45.xml to retrieve information about a file that will appear as images/wave.jpg in the virtual file structure the download manager 34 is creating. The content authority responds with information about the file, such as the file type, file size, and URL from which it can be downloaded. This allows the content source to direct the download manager 34 the best source for the content file. In some embodiments, the content source may direct the download manager 34 to another client node 10 instead of to a server node 14.

In response to its requests for more information, the download manager 34 receives information about all of the requested files (step 418). An exemplary response to that request has the following form:

```
<contentAuthorityResponse
xmlns=“http://www.tld.net/xml/ns/ContentAuthorityResponse”>
  <contentFileInfo
entityURI=“http://theartist.tld.net/contentAuthority/Tld.net/
La53de4cf68c7cd995cD7cb710d1d1d45.xml”
downloadURL=“http://theartist.tld.net/fcs/static/networks/tld.net/
publishers/TheArtistJukebox/channelEntity/content/wave.jpg”
    />
</contentAuthorityResponse>
```

This response directs the download manager 34 to download the file wave.jpg from http://theartist.tld.net/fcs/static/networks/tld.net/publishers/TheArtistJukebox/channelEntity/content/wave.jpg. The download manager 34 downloads the identified content files (step 420). In some embodiments, the download manager 34 issues one or more HTTP GET calls to download the file's contents. The download manager 34 may keep track of how much of the file has been downloaded, so that if it gets interrupted (a common occurrence when downloading large files), it can resume the download at the point it was interrupted. Once downloaded, the download manager 34 will store the file locally at the client node 10. The download manager 34 retrieves any files that have not already been downloaded and stores them locally. This approach allows a content file to be downloaded only once, but shared by multiple channels and programs on the client node 10. It also allows each individual client to determine which new content files it should download for new versions of channels and programs.

Still referring to FIG. 3, the player application 32 displays media content at the client node 10. The player application displays video on a display 24. The player application 32 displays channels, provides channels with the ability to display video, and provides the user with access to the state of the files downloaded for each channel, i.e., the list of programs and their channels, the respective download states of each file, and other options associated with the files. The player application 32 also displays common user interface elements for all channels. Some examples of common user interface elements include a file management tool tab, a “my channels” tool tab, a recommendation tool tab, and a program information tool tab.

The file management tool tab provides information to the user concerning the channels and programs that have been downloaded to the client node 10, together with the state of the download.

The “my channels” tool tab provides information regarding the list of channels to which the user has subscribed. In some embodiments, this tool tab allows the user to click on a channel to begin display of that channel.

The recommendation tool tab displays a window to the user that allows the user to recommend the currently-playing program to a friend. Recommendations may be sent by e-mail or an instant messaging system. For embodiments in which email is sent, the email may contain a JavaScript that automatically installs the download manager 34 and player application 32 on the friend's computer, subscribe the friend to the channel, and start downloading content for the channel.

The program information tool tab displays to the user information about the currently-playing program. In some embodiments, this information is taken directly from the synopsis bundle of the program.

Since a channel is an HTML application, a channel is free to use any ActiveX control or other media player application to display content, such as Windows Media Player manufactured by Microsoft Corp. of Redmond, Wash., or Real Player manufactured by Real Networks. Inc. of Seattle, Wash. For the purposes of the present invention it is preferred to use an “off-the-shelf” media player, such as Windows Media Player, Real Player, or the Quicktime Player manufactured by Apple Computer of Cupertino, Calif. If the overlay memory contains an image (such as a single frame of video), and the video RAM contains graphical elements, the overall effect is that the graphical elements will appear to be displayed on top of the video. This artifact may be used to display semi-transparently interactive elements over video.

The player application 32 of the present invention takes advantage of a common hardware acceleration for video known as overlay memory. In traditional computer systems, video RAM holds data that directly represents the images displayed on the display 24. Overlay memory refers to memory elements separate from video RAM that store data corresponding to images that will be displayed if video RAM stores a particular bit value, known as a color key. Thus, a video image will read video RAM and render an image corresponding to the data stored in video RAM unless that data is the color key. When the video RAM stores the color key, the video engine reads data from the overlay memory to render video on the display 24. The overall effect is that any data elements stored in video RAM appear to be displayed on top of video.

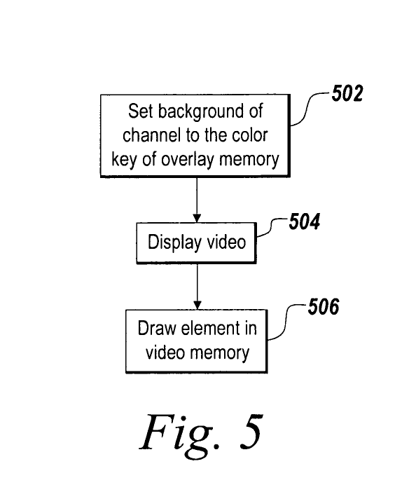

FIG. 5 depicts the steps taken to achieve this effect with standard, “off-the-shelf” media players. A first window, referred to as the “tandem window” is created. An “off-the-shelf” media player component, typically implemented as an ActiveX control, is then instantiated onto this tandem window.

A second window, referred to as the “channel window”, is created and superimposed on the tandem window. In some embodiments the channel window exactly matches the size and position of the tandem window. In other embodiments, the channel window is offset from the tandem window. In still other embodiments, the size and location of the channel window and the tandem window are synchronized so that the channel window always obscures the tandem window.

The channel then instructs the channel window set its entire background color to be that of the color key (step 502). In some embodiments, the channel may set only a portion of the window's background color to be that of the color key (corresponding to where the video should be displayed). In some embodiments, the channel is precoded with the appropriate value for the color key. In other embodiments, the channel retrieves the appropriate value for the color key via an appropriate API call. The actual color used as the color key varies with the type of video. For Windows media files, the color key is #100010. Other media formats have different color keys, but they all tend to be close to black (#000000).

The channel then instructs the media player component that was previously instantiated into the tandem window to begin displaying video. The media player will store the video data into Overlay Memory. Because the Overlay Memory displays where video RAM contains the color key, the video displayed by the media player will appear in those areas where the channel window has set its color to be the color key, even though the tandem window hosting the media player control is obscured by the channel window.

If the channel then wants to display text, graphics, or other interactive elements over the video, it instructs the channel window to store data corresponding to the interactive elements in video RAM (step 506). Since the colors of the interactive elements are different from the color key, and those elements are positioned over the video area, the end result is that the interactive elements appear to float over the video.

Using the color key allows a channel to overlay graphics onto video, producing a compelling effect. However, the effect can be enhanced greatly by placing graphics or text on a semitransparent overlay. For example, text overlaid on video might be difficult to notice or read. But if that text is framed by a box that allows the video to “shine through” dimly, the resulting effect is much closer to the graphic effects used in high-quality television productions.

This sort of effect can be achieved by placing the text or graphical elements on top of a “mesh” image, in which the pixels alternate between black and the transparent color. The pixels that are the transparent color will take on the color of the background image, which will presumably be the color key and will therefore show the video. The remaining pixels will remain black. Since only half of the pixels are showing the video, the result is that the video is “darkened”, and has the effect of being overlaid by a semitransparent graphical element.

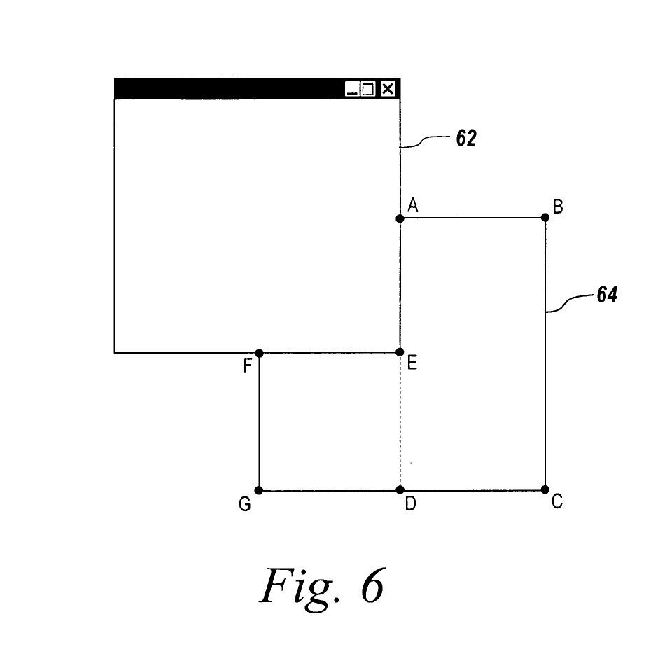

This technique works well in most, but not all, environments. For example, some media player components, when running in some versions of the WINDOWS operating system, will attempt to conserve computing capacity when portions of those media player components are obstructed by other windows. When such a component is obstructed, the component may restrict the display of video to the smallest rectangular region that encompasses all of its unobstructed areas. FIG. 6 shows an embodiment where a channel window 62 obscures a portion of a tandem window 64 and a portion of the underlying tandem window 64 is not be displayed. In FIG. 6, the rectangle of tandem window 64 identified by the points DEFGD will not be rendered by the operating system, leaving the user with a truncated video display identified by the points ABCDEA. This poses a problem for the technique identified above because the overlay elements are treated by the operating system as channel window 62, causing the underlying video to exhibit undesirable clipping artifacts.

In these embodiments, the media player component is instantiated on the tandem window 64 that is, by design, always obscured by the channel window 62. Because of the above conservation, the media player component may display truncated video or no video at all, thereby posing a problem for the technique identified above.

However, because the WINDOWS operating system allows windows to be defined with non-rectangular clipping regions (often used to change the “shape” of a window, even to the point of allowing windows to be created with “holes” in them), the issue may be overcome in the following manner. The channel window's 62 clipping region is changed to create small “holes” corresponding to the corners of the media player component in the underlying tandem window 64. This causes the media player component to be “unobstructed” at those four corners. If the media player component displays the smallest rectangular region that encompasses all the unobstructed areas, and the unobstructed areas are the four corners, then the media player component will be forced to display video in the entire rectangular region, thereby resulting in an untruncated video display. In other embodiments, different clipping regions may be used. For example, instead of creating holes in the corners. the channel window may create four long and thin holes corresponding to the four edges (or a single long thin hole the runs the entire perimeter of the rectangle).

Furthermore, the WINDOWS operating system allows windows to be defined with complex clipping regions such that a region can be defined that outlines a specific non-rectangular region, and the interactive elements and the video can be integrated in a preferred manner. A complex clipping region can be defined by a combination of straight lines and curves to form non-rectangular shapes including polygonal figures. It also can be further defined by the intersection of two or more clipping regions. The channel window's 62 clipping region can be configured to outline a region of the channel window 62 to which video can be viewed, or a viewing region. By the configuration of the clipping region, the channel window 62 is “unobstructed” in this viewing region and will display video from the media player component of an underlying tandem window 64 in the entire viewing region, thereby resulting in an untruncated video display.

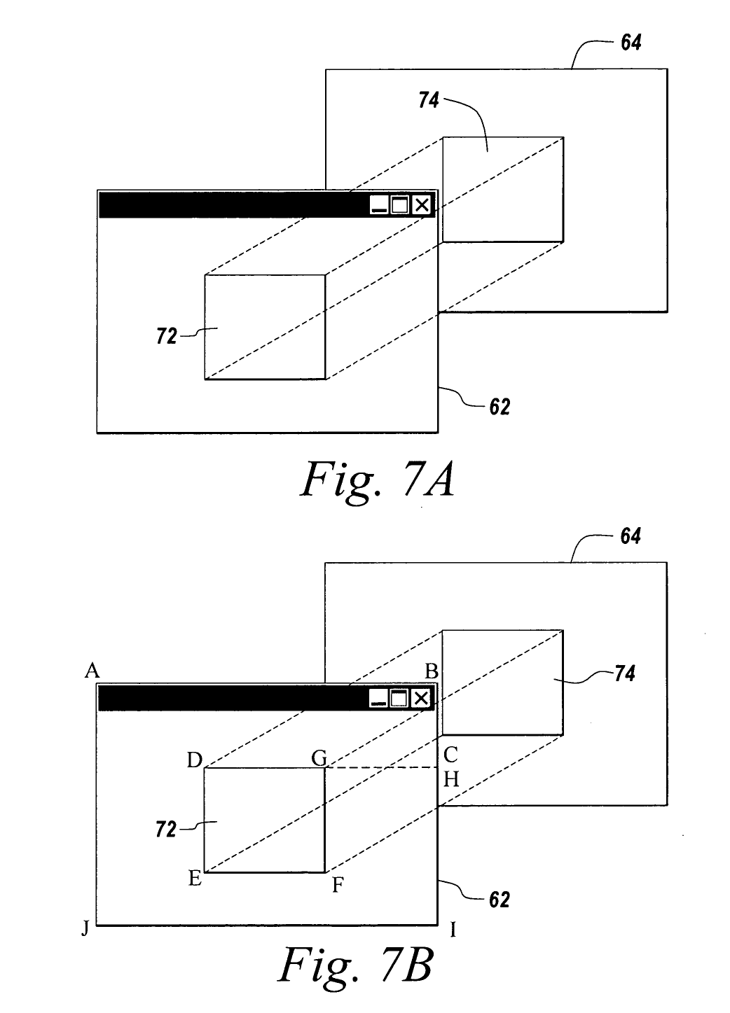

In one embodiment as shown in FIG. 7A, a first window, or channel window 62 has a viewing region 72 allocated to showing video being displayed from a second window, or the tandem window 64. The tandem window 64 hosts a media player 74 for displaying video. The media player 74 may be a media player control, such as the Windows Media Player control. In alternative embodiments, the media player 74 may display other interactive or graphical elements instead of or in addition to video. The media player 74 may occupy a portion of the tandem window 64 as depicted in FIG. 7A. In another embodiment, the media player 74 and the tandem window 64 are sized such that the media player 74 occupies most or all of the tandem window 64. The tandem window 64 may be the same size as the channel window 62 or may be smaller than the channel window 62. In one embodiment, the media player 74 and the tandem window 64 are sized to fit in the viewing region 72 of the channel window 62. Furthermore, the tandem window 64 is positioned behind the channel window 62 so that the channel window 62 obstructs viewing of the tandem window 64. In an exemplary embodiment, the tandem window 64 is positioned behind the channel window 62 so that the channel window 62 always obstructs the tandem window 64. The position of the channel window 62 and the tandem window 64 are synchronized so that as the channel window 62 is re-positioned the tandem window 64 is likewise re-positioned to remain obstructed by the channel window 62. In an exemplary embodiment, the position of the media player 74 is synchronized to always be in the same position as the viewing region 72 of the channel window 62. In this manner, a user viewing the channel window 62 is unaware that there is a tandem window 64 behind the channel window 62.

Still referring to FIG. 7A. the viewing region 72 of the channel window 62 is meant to show video displayed from the media player 74 hosted by the tandem window 64 while the tandem window 64 is positioned behind the channel window 62. Without modifying the default clipping region of WINDOWS operating system, the channel window 62 would obstruct the tandem window 64 positioned behind it. The viewing region 72 of the channel window 62 and the media player 74 of the tandem window may be in the same position and occupy the same viewing area. Therefore, the viewing region 72 of the channel window 62 obstructs the viewing of the video displayed by the media player 74 of the tandem window 64. As such, the video being displayed by the media player 74 will not be seen in the viewing region 72 of the channel window 62, or have the effect of being seen in the viewing region 72. In order to show the video displayed by the media player 74 of the tandem window 64 in the viewing region 72 of the channel window 62, the clipping region of the channel window 62 is modified.

FIG. 7B depicts a clipping region to provide an unobstructed view of the video display of the media player 74 so that it shows in the viewing region 72 of the channel window 62. By default, the WINDOWS operating system provides the channel window 62 with the clipping region ABIJ. In this case, any portion of the tandem window 64 displayed behind the clipping region ABIJ of the channel window 62 would not be viewable. If the clipping region is modified to ABCDEFGHIJ to clip a region around the viewing region 72, then a “hole” is effectively created that will display that portion of a window behind the channel window 62 and occupying the region DEFG. In this case, the video displayed in the media player 74 of the tandem window 64 will be displayed through this “hole” of region DEFG. This technique makes the channel window 62 appear to be displaying video in the viewing region 72 although the video is being displayed in a media player 74 of the tandem window 64 hidden behind the channel window 62,

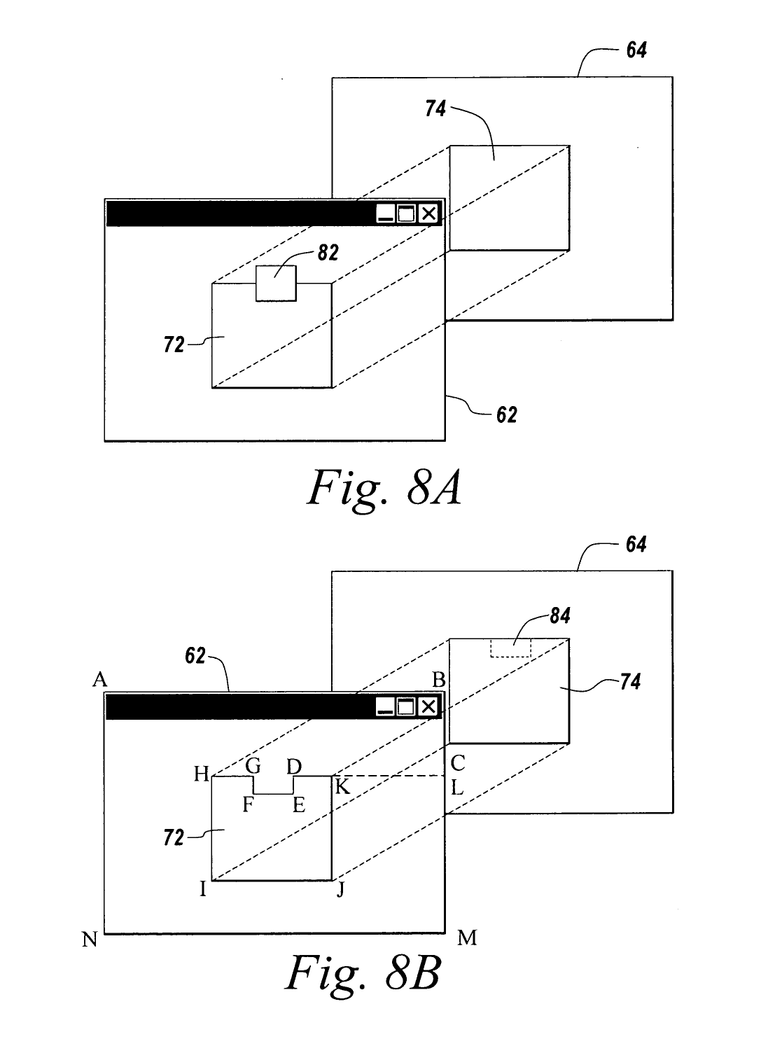

FIG. 8A depicts an exemplary embodiment where an overlay element is to be displayed over the video. The channel window 62 has a viewing region 72 for showing video displayed from the media player 74 of the tandem window 64. The channel window 62 has a display element 82, or overlay, to display over the video. The display element 82 could be any combination of text, graphics or interactive elements. The display element 82 may provide interaction with the user, such as a graphical menu, while the video from the tandem window 64 is displayed in the viewing region 72. This allows the user to view the video while interacting with any functionality exposed by the system through channel window 62. If the channel window 62 has the same clipping region as defined in FIG. 7B, the portion of the display element 82 occupying a portion of the viewing region 72 would not be viewed. The video from the media player 74 would show in the entire viewing region 72, clipping a portion of the display element 82. In order for the user to view the entire display element 82 with a portion occupying the viewing region 72 and have the video displayed by the media player 74 occupy the remaining portion of the viewing region 72, a more complex clipping region for the channel window 62 is defined.

FIG. 8B depicts a clipping region to support the display element 82 being displayed over a portion of the viewing region 72 of the channel window 62. The clipping region is modified to the points of ABCDEFGHIJKLMN as shown in FIG. 8B. This has the effect of creating a non-rectangular “hole” of DEFGHIJK. The tandem window 64 can be positioned behind the channel window 62 such that the video displayed in the media player 74 of the tandem window 64 is shown in the region defined by the points of DEFGHIJK. Effectively, the portion 84 of the video being displayed by the media player 74 will not be shown in the viewing region 72 of the channel window 62. The display element 82 will be viewed in the viewing region 72 over this portion 84. In this manner, the display element 82 is fully shown in the channel window 62 and displayed so that it effectively appears to be displayed over the video shown in the portion of the viewing region 72 defined by the points DEFGHIJK.

In a further embodiment, the display element 82 of FIG. 8A is displayed semi-transparently using the systems and methods described above. In another embodiment, there is a plurality of display elements (e.g., 82, 82′, 82″) being displayed in the channel window 62 at the same time and displayed over any video displayed in the viewing region 72. One or more of the plurality of display elements (e.g., 82, 82′, 82″) may be displayed semi-transparently. In another embodiment, there is a plurality of media players (e.g., 74, 74′, 74″) displaying video in each of a plurality of tandem windows (e.g., 64, 64′, 64″). In yet another embodiment, a single tandem window 64 has multiple media players (e.g., 74, 74′, 74″). Clipping regions of the channel window 62 can be defined to have multiple viewing regions (e.g., 72, 72′, 72″) to view video from multiple media players (e.g., 74, 74′, 74″), either running on a single tandem window 64 or multiple tandem windows (e.g., 64, 64′, 64″). One ordinarily skilled in the art will appreciate the various combinations of viewing regions, display elements, media players and tandem windows that can be formed to integrate the display of one or more video elements with one or more display elements, semi-transparently or otherwise, in the channel window.

The player application may expose a number of functions for playing video files. In some embodiments, these functions are contained by an object represented the player application 32. For example, to play a video, the channel can call an open function exposed by the player application object, passing in the local filename of the video to be played. For example, the following code will open the “video.wmv” file in a program's content bundle:

var player = external.mediaPlayer;
var file = program.getContentFileByName (“video.wmv”);
if (file) {
player.open (file.localFile);
}

Any URL can be specified to the open( ) method, not just filenames. In these embodiments, the channel can play not just locally cached files, but also files on the internet or even streaming media.

The following additional commands may be provided by the player application object to control the video:

| | |
|---|---|
| play( ), stop( ), pause( ) | Plays, stops, or pauses the video |
| fastForward( ), | Seeks through the video at high speed. |
| fastReverse( ) | |
| frameForward( ), | Moves the video frame by frame forward or |
| frameReverse( ) | backwards |
| setPosition(seconds) | Sets the video to be positioned at the specified |
| | number of seconds from the beginning. The |
| | number of seconds may be fractional. |
| setMute(mute) | The value of mute should be 1 or 0, where 1 |
| | means mute any audio coming from the player, |
| | and 0 means unmute. |
| setVolume(volume) | Sets the volume of any audio coming from the |
| | player, where 0 is silence and 100 is full |
| | volume. |

As noted above, the player application can expand the video to fill the window. In some embodiments, the player application 32 will maintain the aspect ratio of the video, which means that there may be a “letterbox” effect in which the top and bottom or the sides will show no video. In these embodiments, the video remains centered in the window. The channel can specify the position of the video within the window edges. This may done with the following function presented by the player application object.

| | |
|---|---|
| setInsets(leftInset, topInset, | Sets the border for the video to be the |
| rightInset, bottomInset) | specified number of pixels away from the |
| | window's edge. |

In some embodiments, as media is being opened and played, it generates asynchronous callbacks that the channel may want to see. These callbacks are sent as events to the “external” object, so the channel can capture one of these events by defining a function named “external::{eventName}”. The following describes the various callbacks. Each callback passes back the “mediaURL” that was specified in the “open( )” command.

external::mediaInfoReceived(mediaInfo,mediaURL)

This is called after the media is opened, but before it is played. After the channel calls open( ) and that call returns, some time might pass before the player is able to open the media and examine it to find out some basic information. Once it does, it fires this event.

| | |
|---|---|
| overlayColor | The color key that should be used for this video. The |
| | color key is of the form “RRGGBB”, where RR, GG, |
| | and BB are hexadecimal digits. For example, a |
| | windows media file would have a color key of |
| | “100010”. Don't forget to prepend the “#” |
| | character when using this in HTML. |
| width | The height of the media, in pixels |
| height | The height of the media, in pixels |
| duration | The duration of the media, in seconds |
| canPlay | 1 if the mediaPlayer.play( ) command can be used with |
| | this media, 0 if not |
| canStop | 1 if the mediaPlayer.stop( ) command can be used with |
| | this media, 0 if not |
| canPause | 1 if the mediaPlayer.pause( ) command can be used |
| | with this media, 0 if not |
| canFastForward | 1 if the mediaPlayer.fastForward( ) command can be |
| | used with this media, 0 if not |
| canFastReverse | 1 if the mediaPlayer.fastReverse( ) command can be |
| | used with this media, 0 if not |
| canFrameForward | 1 if the mediaPlayer.frameForward( ) command can be |
| | used with this media, 0 if not |
| canFrameReverse | 1 if the mediaPlayer.frameReverse( ) command can be |
| | used with this media, 0 if not |
| canSetPosition | 1 if the mediaPlayer.setPosition( ) command can be |
| | used with this media, 0 if not |

external::playStateChanged(playState,mediaURL)

As the media player opens and plays a media selection, it can go through several “play states”. The channel may wish to display these play states to the user to give some idea of what the player is doing. This is especially true for streaming media, where the “buffering” or “waiting” play states tell the user that something is going on even if no video is playing.

The names of the play states may vary between media types. However, all media types will generate a “mediaEnded” play state when the media finishes playing, which may be very useful to some channels.

external::mediaStoppedByUser(mediaURL)

This is called if the playback of media is stopped explicitly by the user (presumably by pressing the “stop” button). This allows the channel to distinguish between media stopping because the user requested it, or because it reached the end on its own.

external::mediaPositionChanged(seconds,mediaURL)

As the media plays, this callback updates the channel with the current position of the player within the media. The position is specified in seconds (which may be fractional).

While the invention has been shown and described with reference to specific preferred embodiments, it should be understood by those skilled in the art that various changes in form and detail may be made therein without departing from the spirit and scope of the invention as defined by the following claims.

What is claimed is:

1. A system for displaying media output integrated with display elements, the system comprising:
a first window having a media player;
a second window having at least one of a plurality of display elements; and
an application program configured to display output of the media player of the first window in a portion of the second window, and to superimpose, in the portion of the second window, the display of the least one of the plurality of display elements and the display of the output of the media player.

2. The system of claim 1, wherein the media player comprises a Windows Media Player application.

3. The system of claim 1, wherein the output of the media player comprises video.

4. The system of claim 1, wherein the application program is further configured to semi-transparently superimpose the display of the least one of the plurality of display elements and the display of the output of the media player.

5. The system of claim 1, wherein the application program is further configured to display the least one of the plurality of display elements floating over the portion of the second window.

6. The system of claim 1, wherein a size and location of the second window and a size and location of the first window are synchronized to obscure the view of the first window by the second window.

7. The system of claim 1, wherein the second window comprises a clipping region, the clipping region configured to show the display of the output of the media player from the first window in the portion of the second window.

8. The system of claim 1, wherein the second window comprises a clipping region, the clipping region configured to show in the portion of the second window the display of the least one of the plurality of display elements from the second window and the display of the output of the media player from the first window.

9. The system of claim 1, wherein the position of the media player in the first window is synchronized with the position of the portion of the second window.

10. The system of claim 1, wherein the application program comprises a thread process.

11. The system of claim 1, wherein the application program comprises one of the group consisting of an ActiveX control, a JAVA applet.

12. The system of claim 11, wherein the application program further comprises an application programming interface to control the displaying of the output of the media player.

13. The system of claim 11, wherein the application program further comprises an application programming interface to control the displaying of the least one of the plurality of display elements.

14. The system of claim 11, wherein the application program further comprises an application programming interface to control the size and location of one of the first window and the second window.

15. The system of claim 1, wherein the least one of one the plurality of display elements comprises an interactive display element.

16. The system of claim 1, wherein the least one of the plurality of display elements comprises text.

17. The system of claim 1, wherein the least one of the plurality of display elements comprises graphics.

18. A method for integrating displaying of display elements with displaying of media output, the method comprising the steps of:
(a) displaying the output of a media player in a first window;
(b) displaying at least one of a plurality of display elements in a second window; and
(c) superimposing, in a portion of the second window, the displaying of the least one of the plurality of display elements and the displaying of the output of the media player.

19. The method of claim 18, wherein the media player comprises a Windows Media Player application.

20. The method of claim 18, wherein step (a) comprises displaying video output of a media player in a first window.

21. The method of claim 18, wherein step (c) comprises semi-transparently superimposing, in the portion of the second window, the displaying of the least one of the plurality of display elements and the displaying of the output of the media player.

22. The method of claim 18, wherein step (c) further comprises displaying the least one of the plurality of display elements floating over the portion of second window.

23. The method of claim 18, further comprising the step of synchronizing a size and location of the second window with a size and location of the first window to obscure the view of the first window by the second window.

24. The method of claim 18, wherein step (c) further comprises configuring a clipping region to show the display of the output of the media player from the first window in the portion of the second window.

25. The method of claim 18, wherein step (c) further comprises configuring a clipping region to show in the portion of the second window the display of the least one of the plurality of display elements from the second window and the display of the output of the media player from the first window.

26. The method of claim 18, further comprising the step of synchronizing the position of the media player in the first window with the position of the portion of the second window.

27. The method of claim 18, further comprising the step of providing an application programming interface to control the displaying of the output of the media player.

28. The method of claim 18, further comprising the step of providing an application programming interface to control the displaying of the least one of the plurality of display elements.

29. The method of claim 18, further comprising the step of providing an application programming interface to control the size and location of one of the first window and the second window.

30. The method of claim 18, wherein the least one of one the plurality of display elements comprises an interactive display element.

31. The method of claim 18, wherein the least one of the plurality of display elements comprises text.

32. The method of claim 18, wherein the least one of the plurality of display elements comprises graphics.

33. An article of manufacture having embodied thereon computer-readable program means for integrating display elements with the display of media output, the article of manufacture comprising:
(a) computer-readable program means for displaying the output of a media player in a first window;
(b) computer-readable program means for displaying at least one of a plurality of interactive elements in a second window; and
(c) computer-readable program means for superimposing, in a portion of the second window, the displaying of the least one of the plurality of display elements and the displaying of the output of the media player.

34. The article of manufacture of claim 33, wherein the media player comprises a Windows Media Player application.

35. The article of manufacture of claim 33, wherein step (a) comprises computer-readable program means for displaying video output of a media player in a first window.

36. The article of manufacture of claim 33, wherein step (c) comprises computer-readable means for semi-transparently superimposing, in the portion of the second window, the displaying of the least one of the plurality of display elements and the displaying of the output of the media player.

37. The article of manufacture of claim 33, wherein step (c) further comprises computer-readable program means for displaying the least one of the plurality of display elements floating over the portion of second window.

38. The article of manufacture of claim 33, further comprising computer-readable program means for synchronizing a size and location of the second window with a size and location of the first window to obscure the view of the first window by the second window.

39. The article of manufacture of claim 33, wherein step (c) further comprises computer-readable program means for configuring a clipping region to show the display of the output of the media player from the first window in the portion of the second window.

40. The article of manufacture of claim 33, wherein step (c) further comprises computer-readable program means for configuring a clipping region to show in the portion of the second window the display of the least one of the plurality of display elements from the second window and the display of the output of the media player from the first window.

41. The article of manufacture of claim 33, further comprising computer-readable program means for synchronizing the position of the media player in the first window with the position of the portion of the second window.

42. The article of manufacture of claim 33, further comprising computer-readable program means for providing an application programming interface to control the displaying of the output of the media player.

43. The article of manufacture of claim 33, further comprising computer-readable program means for providing an application programming interface to control the displaying of the least one of the plurality of display elements.

44. The article of manufacture of claim 33, further comprising computer-readable program means for providing an application programming interface to control the size and location of one of the first window and the second window.

45. The article of manufacture of claim 33, wherein the least one of one the plurality of display elements comprises an interactive display element.

46. The article of manufacture of claim 33, wherein the least one of the plurality of display elements comprises text.

47. The article of manufacture of claim 33, wherein the least one of the plurality of display elements comprises graphics.
